(19) United States
(12) Patent Application Publication
(10) Pub. No.: US 2021/0339541 A1
(43) Pub. Date: Nov. 4, 2021

(54) IMAGE FORMING APPARATUS AND CONVEYING APPARATUS

(71) Applicant: Hiroki Takahashi, Kanagawa (JP)

(72) Inventor: Hiroki Takahashi, Kanagawa (JP)

(73) Assignee: Ricoh Company, Ltd., Tokyo (JP)

(21) Appl. No.: 17/239,846

(22) Filed: Apr. 26, 2021

(30) Foreign Application Priority Data
Apr. 30, 2020 (JP) 2020-080828

(51) Int. Cl. B41J 11/00; G06F 3/12

(52) U.S. Cl. CPC B41J 11/0095; G06F 3/1296; G06F 3/1211; G06F 3/121

(57) ABSTRACT

An image forming apparatus includes a feeding roll, a feeding motor, a winding roll, a winding motor, a platen, a conveying roller, a sensor, and circuitry. The feeding motor rotates the feeding roll to feed a recording medium wound around the feeding roll. The winding motor rotates the winding roll to wind the recording medium around the winding roll. The platen is disposed between the feeding roll and the winding roll and supports the recording medium that moves between the feeding roll and the winding roll. The conveying roller conveys the recording medium supported by the platen toward the winding roll. The sensor detects an end position of the recording medium in a conveyance direction. The circuitry corrects a feeding amount of the recording medium by the conveying roller with a correction value according to the end position of the recording medium detected by the sensor.

### CROSS-REFERENCE TO RELATED APPLICATION

This patent application is based on and claims priority pursuant to 35 U.S.C. § 119(a) to Japanese Patent Application No. 2020-080828, filed on Apr. 30, 2020, in the Japan Patent Office, the entire disclosure of which is hereby incorporated by reference herein.

### BACKGROUND

### Technical Field

Embodiments of the present disclosure relate to an image forming apparatus and a conveying apparatus.

### Related Art

There are known inkjet printers that discharge ink from a recording head to form an image on a recording medium.

For example, in order to enhance image quality, the feeding amount of a recording medium is corrected based on the amount of deviation of a leading end position of the recording medium. Further, since the frictional force generated between a recording medium and a platen supporting the recording medium varies depending on the leading end position of the recording medium, the drive amount of a roll body around which the recording medium is wound is corrected according to the leading end position of the recording medium.

### SUMMARY

According to an aspect of the present disclosure, there is provided an image forming apparatus that includes a feeding roll, a feeding motor, a winding roll, a winding motor, a platen, a conveying roller, a sensor, and circuitry. The feeding motor rotates the feeding roll to feed a recording medium wound around the feeding roll. The winding motor rotates the winding roll to wind the recording medium around the winding roll. The platen is disposed between the feeding roll and the winding roll and supports the recording medium that moves between the feeding roll and the winding roll. The conveying roller conveys the recording medium supported by the platen toward the winding roll. The sensor detects an end position of the recording medium, which is supported by the platen, in a conveyance direction. The circuitry corrects a feeding amount of the recording medium by the conveying roller with a correction value according to the end position of the recording medium detected by the sensor.

According to another aspect of the present disclosure, there is provided a conveying apparatus that includes a feeding roll, a feeding motor, a winding roll, a winding motor, a platen, a conveying roller, a sensor, and circuitry. The feeding motor rotates the feeding roll to feed a sheet material wound around the feeding roll. The winding motor rotates the winding roll to wind the sheet material around the winding roll. The platen is disposed between the feeding roll and the winding roll and supports the sheet material that moves between the feeding roll and the winding roll. The conveying roller conveys the sheet material supported by the platen toward the winding roll. The sensor detects an end position of the sheet material, which is supported by the platen, in a conveyance direction. The circuitry corrects a feeding amount of the sheet material by the conveying roller with a correction value according to the end position of the sheet material detected by the sensor.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of an example of a configuration of an image forming apparatus according to an embodiment of the present disclosure;

FIG. 2 is a side view of an example of a configuration of a conveying mechanism included in an image forming apparatus according to an embodiment of the present disclosure;

FIG. 3 is a top view of an example of a configuration in the vicinity of a carriage of an image forming apparatus according to an embodiment of the present disclosure;

FIG. 4 is a top view of an example of a configuration in the vicinity of a carriage of an image forming apparatus according to an embodiment of the present disclosure;

FIG. 5 is a block diagram of an example of a functional configuration of an image forming apparatus according to an embodiment of the present disclosure;

FIG. 6 is a graph illustrating an example of transition of a conveyance load in an image forming apparatus according to an embodiment of the present disclosure;

FIG. 7 is a diagram illustrating an example of a correction value table held by the image forming apparatus according to an embodiment of the present disclosure;

FIG. 8A is a schematic view illustrating a state in which an adjustment chart is printed on a test medium by an image forming apparatus according to an embodiment of the present disclosure;

FIG. 8B is a graph illustrating relation between leading end position of the test medium of FIG. 8A and conveyance load during conveyance of the test medium;

FIG. 8C is a graph illustrating relation between leading end position of the test medium of FIG. 8A and feeding amount during conveyance of the test medium;

FIG. 8D is a graph illustrating relation between leading end position of the test medium of FIG. 8A and pitch of adjustment lines of an adjustment chart;

FIG. 9 is a diagram illustrating an example of a correction value table held by an image forming apparatus according to an embodiment of the present disclosure;

FIG. 10 is a flowchart illustrating an example of a procedure of printing processing by an image forming apparatus according to an embodiment of the present disclosure; and

FIG. 11 is a flowchart illustrating an example of a procedure for calculating a correction value by an image forming apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

With reference to drawings, descriptions are given below of embodiments of the present disclosure. It is to be noted that elements (for example, mechanical parts and components) having the same functions and shapes are denoted by the same reference numerals throughout the specification and redundant descriptions are omitted.

Hereinafter, embodiments of the present disclosure are described with reference to drawings.

### Example of Configuration of Image Forming Apparatus

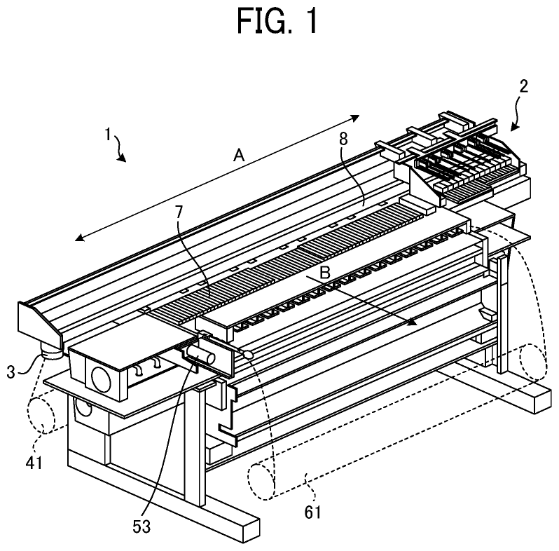

FIG. 1 is a diagram illustrating an example of the configuration of an image forming apparatus 1 according to an embodiment of the present disclosure. As illustrated in FIG. 1, the image forming apparatus 1 includes a carriage 2, a main scanning motor 3, a sub-scanning motor 53, a platen 7, and a guide rod 8.

The carriage 2 includes a plurality of inkjet recording heads. Each recording head discharges ink of a predetermined color. The recording heads are mounted on the carriage 2 so that a discharge surface of each recording head faces downward.

The carriage 2 is supported by a guide rod 8 extending along a main scanning direction A. The main scanning motor 3 is driven to reciprocate the carriage 2 along the main scanning direction A.

The platen 7 is provided at a position facing the discharge surface of the carriage 2 from which ink is discharged. The platen 7 is configured by connecting a plurality of plate-shaped members in the main scanning direction A, for example, and supports a recording medium when ink is discharged from the carriage 2 onto the recording medium.

Recording media are long printable objects having various sizes, materials, thicknesses, etc., such as a paper medium or a vinyl chloride medium. A sub-scanning motor 53 is driven to intermittently convey a recording medium in a sub-scanning direction B, which is a conveyance direction of the recording medium.

In other words, once the sub-scanning motor 53 is driven and the recording medium conveyed to a predetermined position is temporarily stopped, the main scanning motor 3 is driven during that time and the carriage 2 reciprocates in the main scanning direction A along the guide rod 8 while discharging ink from the recording heads to the recording medium. Thus, images such as characters, figures, pictures, and photographs are formed on the recording medium.

A feeding roll 41 having a feeding motor is provided on the rear side of the image forming apparatus 1 in the sub-scanning direction B. A winding roll 61 having a winding motor is provided on the front side of the image forming apparatus 1 in the sub-scanning direction B. The recording medium is drawn out from the feeding roll 41 and set on the platen 7 in a state of being wound around the feeding roll 41. After a predetermined image is printed on the platen 7, the recording medium is wound on the winding roll 61.

As described above, the image forming apparatus 1 is configured as, for example, an inkjet printer including an inkjet recording head. The image forming apparatus 1 is also, for example, a serial printer that moves the carriage 2 to perform printing. The image forming apparatus 1 may be configured as a wide machine having a long moving distance of the carriage 2 in the main scanning direction A. Alternatively, the image forming apparatus 1 may form an image by an electrophotographic method.

### Example of Configuration of Conveying Mechanism

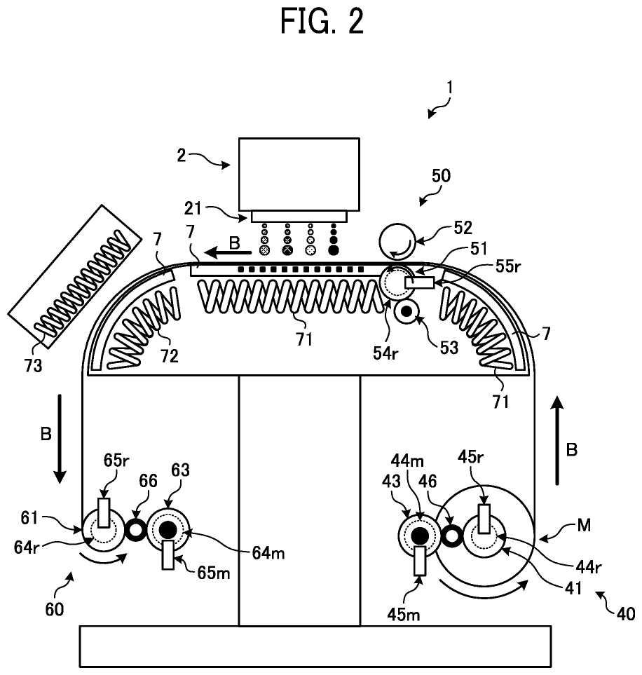

Next, details of a conveying mechanism of the image forming apparatus 1 are described with reference to FIG. 2. FIG. 2 is a diagram illustrating an example of a configuration of a conveying mechanism included in the image forming apparatus 1 according to the present embodiment.

As illustrated in FIG. 2, the conveying mechanism of the image forming apparatus 1 includes a feeding unit 40, a conveying unit 50, and a winding unit 60. The feeding unit 40 is disposed on the rear side of the image forming apparatus 1. The winding unit 60 is arranged on the front side of the image forming apparatus 1. The conveying unit 50 is disposed upstream from a position of the platen 7 directly below the carriage 2.

A recording medium M is pulled out onto the platen 7 via the conveying unit 50 in a state of being set in the feeding unit 40. After printing is performed on the platen 7 by the recording head 21 included in the carriage 2, the recording medium M is collected onto the winding unit 60.

One end of the platen 7 extends and falls toward the feeding unit 40 and the other end of the platen 7 extends and falls toward the winding unit 60 across a printing area directly below the carriage 2.

Further, the platen 7 is provided with small holes at least in the printing area directly below the carriage 2 and is configured to attract the recording medium M onto the platen 7 by a fan. Such a configuration can restrain the floating of the recording medium M from the platen 7 and convey the recording medium M along the platen 7.

Heaters 71 are provided on the back surface of the platen 7 on the feeding unit 40 side and the back surface of the printing area of the platen 7. A post heater 72 is provided on the back surface of the platen 7 on the winding unit 60 side, and a cure heater 73 is provided above the platen 7 on the winding unit 60 side. The platen 7 is preheated by the heater 71 so that the ink adhering to the recording medium M is rapidly cured. The ink on the recording medium M is further cured by the post heater 72 and the cure heater 73 and fixed on the recording medium M.

The feeding unit 40 includes a feeding roll 41, a feeding motor 43, encoder sheets 44r and 44m, encoder sensors 45r and 45m, and a torque limiter 46.

The recording medium M is wound around the feeding roll 41. The feeding motor 43 serves as a drive source to generate tension on the feeding unit 40 side. The tension applied to the recording medium M is adjusted by the torque limiter 46.

The encoder sheet 44r is attached on the rotation shaft of the feeding roll 41 and detects the amount of rotation of the feeding roll 41. The encoder sensor 45r detects the remaining amount of the recording medium M based on the amount of rotation of the feeding roll 41 detected by the encoder sheet 44r.

The encoder sheet 44m is mounted on the rotation shaft of the feeding motor 43 and detects the amount of rotation of the feeding motor 43. The encoder sensor 45m detects the rotation speed of the feeding motor 43 based on the rotation amount of the feeding motor 43 detected by the encoder sheet 44m.

When the feeding motor 43 is rotated to apply a force in the direction opposite to the sub-scanning direction B, which is the conveyance direction of the recording medium M, tension is applied to the recording medium M held by a conveying roller 51 and a pressure roller 52 of the conveying unit 50. Accordingly, the torque limiter 46 of the feeding unit 40 starts to slide.

Thus, a feeding tension for feeding the recording medium M is formed by the torque limiter 46 and is applied to the recording medium M. Accordingly, as the feeding roll 41 rotates, the recording medium M is fed onto the platen 7. Thus, the tension between the feeding unit 40 and the conveying unit 50 is kept constant.

The conveying unit 50 includes the conveying roller 51, the pressure roller 52, the sub-scanning motor 53, an encoder sheet 54r, and an encoder sensor 55r.

The sub-scanning motor 53 as a conveying motor serves as a drive source for rotating the conveying roller 51. The pressure roller 52 applies pressure to the conveying roller 51 side in order to transmit the power of the conveying roller 51 to the recording medium M.

The encoder sheet 54r is mounted on the rotation shaft of the conveying roller 51 and detects the amount of rotation of the conveying roller 51. The encoder sensor 55r detects the rotation speed of the conveying roller 51 based on the amount of rotation of the conveying roller 51 detected by the encoder sheet 54r.

When the sub-scanning motor 53 is rotated with the recording medium M sandwiched between the conveying roller 51 and the pressure roller 52, the conveying roller 51 is rotated and the recording medium M is conveyed in the sub-scanning direction B.

The feeding unit 40 and the conveying unit 50 are intermittently driven.

Accordingly, the recording medium M is intermittently moved on the platen 7 during intervals between reciprocations of the carriage 2 in the main scanning direction A by the above-mentioned main scanning motor 3.

The winding unit 60 includes a winding roll 61, a winding motor 63, encoder sheets 64r and 64m, encoder sensors 65r and 65m, and a torque limiter 66.

The recording medium M, which has been collected after completion of printing, is wound around the winding roll 61. The winding motor 63 serves as a drive source for generating tension on the winding unit 60 side. The tension applied to the recording medium M is adjusted by the torque limiter 66.

The encoder sheet 64r is mounted on the rotation shaft of the winding roll 61 and detects the amount of rotation of the winding roll 61. The encoder sensor 65r detects the winding amount of the recording medium M based on the rotation amount of the winding roll 61 detected by the encoder sheet 64r.

The encoder sheet 64m is mounted on the rotation shaft of the winding motor 63 and detects the amount of rotation of the winding motor 63. The encoder sensor 65m detects the rotation speed of the winding motor 63 based on the amount of rotation of the winding motor 63 detected by the encoder sheet 64 m.

When the winding motor 63 is rotated, the torque limiter 66 slides out to form a winding tension for winding the recording medium M, and the winding tension is applied to the recording medium M. Thus, as the winding roll 61 rotates, the recording medium M is wound by the winding roll 61.

As described above, the image forming apparatus 1 is also configured as a conveying apparatus that conveys a recording medium M as a sheet material by the conveying mechanism including the feeding unit 40, the conveying unit 50, and the winding unit 60.

### Configuration Example of Sensor

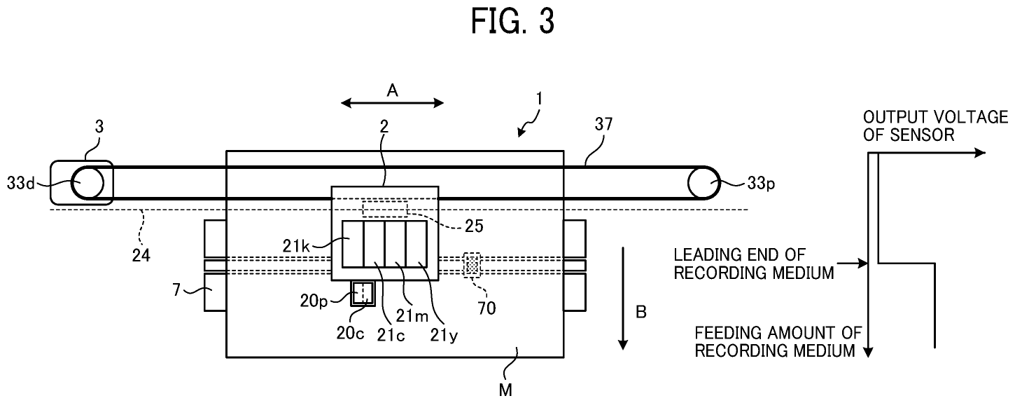

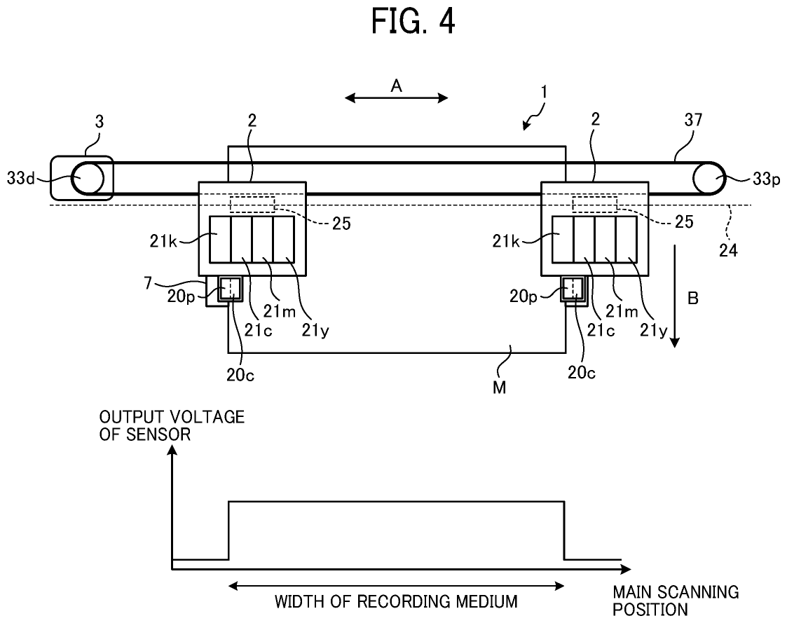

Next, various sensors included in the image forming apparatus 1 are described with reference to FIGS. 3 and 4. FIGS. 3 and 4 are top views illustrating an example of the configuration in the vicinity of the carriage 2 of the image forming apparatus 1 according to an embodiment of the present disclosure.

As illustrated in FIG. 3, an optical sensor 70 is embedded in the plane of the platen 7 at the position that a recording medium M passes. The optical sensor 70 is, for example, a reflection type photoelectric sensor or the like and detects the leading end position of a long recording medium M in the sub-scanning direction B.

As illustrated in the graph in FIG. 3, for example, when the leading end position of the recording medium M conveyed in the sub-scanning direction B approaches the embedded position of the optical sensor 70, the light irradiated from the optical sensor 70 and reflected by the recording medium M is detected by the optical sensor 70. Accordingly, the output voltage of the optical sensor 70 rises, and it is detected that the leading end position of the recording medium M reaches the position of the optical sensor 70 at that timing.

During the conveyance of the recording medium M, the output voltage of the optical sensor 70 is maintained high while the recording medium M is on the platen 7. When the trailing end position of the recording medium M in the sub-scanning direction B passes over the optical sensor 70, the reflected light from the recording medium M is interrupted, and the output voltage of the optical sensor 70, which has been at a high value until then, drops.

Thus, the optical sensor 70 can also detect the trailing end position of the recording medium M. In other words, as the output voltage of the optical sensor 70 drops, it is detected that the trailing end position of the recording medium M has reached the position of the optical sensor 70.

The optical sensor 70 can detect the leading end position of the recording medium M even when the recording medium M is rewound on the platen 7, that is, when the recording medium M is conveyed in the direction opposite to the sub-scanning direction B.

The carriage 2 includes, for example, a recording head 21y that discharges yellow ink, a recording head 21m that discharges magenta ink, a recording head 21c that discharges cyan ink, and a recording head 21k that discharges black ink. The individual recording heads 21y, 21m, 21c, 21k, which hereinafter may be collectively referred to as recording heads 21 unless distinguished, are mounted on the carriage 2 so that discharge surfaces of the recording heads 21y, 21m, 21c, 21k face downward, in other words, toward the recording medium M side.

The carriage 2 is also mounted with optical sensors 20p and 20c. The optical sensor 20p is, for example, a reflective photoelectric sensor or the like, and detects the width of the recording medium M, that is, both end portions of the recording medium M in the main scanning direction A. The optical sensor 20c is, for example, a two-dimensional image sensor or the like in which a plurality of solid-state image sensors such as CCD (Charge Coupled Device) or CMOS (Complementary Metal-Oxide Sensor) are arranged in a plane, and can read an image printed on a recording medium M or the like.

The carriage 2 is connected to a timing belt 37 bridged between a drive pulley 33d and a pressure pulley 33p. The timing belt 37 is driven by the main scanning motor 3 via the drive pulley 33d, so that the carriage 2 reciprocates along the main scanning direction A. Since tension is applied to the timing belt 37 by the pressure pulley 33p, the carriage 2 is driven without slack of the timing belt 37.

The encoder sensor 25 provided on the carriage 2 detects a mark on the encoder sheet 24 spanning both side plates of the image forming apparatus 1, to control the movement of the carriage 2 in the main scanning direction A.

The optical sensor 20p utilizes the movement of the carriage 2 as described above to detect the width of the recording medium M.

As illustrated in FIG. 4, the carriage 2 moves from one end side to the other end side of the platen 7 in the main scanning direction A in a state in which the optical sensor 20p irradiates the lower platen 7 side with light. A tape that restrains the reflection of light from the optical sensor 20p is attached to the platen 7, for example.

As illustrated in the graph in FIG. 4, when the optical sensor 20p approaches above an end of the recording medium M in the width direction from above the platen 7 with the movement of the carriage 2, the output voltage of the optical sensor 20p rises. While the optical sensor 20p is moving on the recording medium M, the output voltage of the optical sensor 20p is maintained high. When the optical sensor 20p passes over the other end of the recording medium M, the output voltage of the optical sensor 20p drops.

As described above, the position at which the output voltage of the optical sensor 20p rises and the position at which the output voltage drops are detected as the ends of the recording medium M in the width direction. For example, in a serial printer in which the carriage 2 moves, such as the image forming apparatus 1 of the present embodiment, the width of the recording medium M is detected as described above to restrain, for example, erroneous printing on the platen 7.

### Example of Functional Block of Image Forming Apparatus

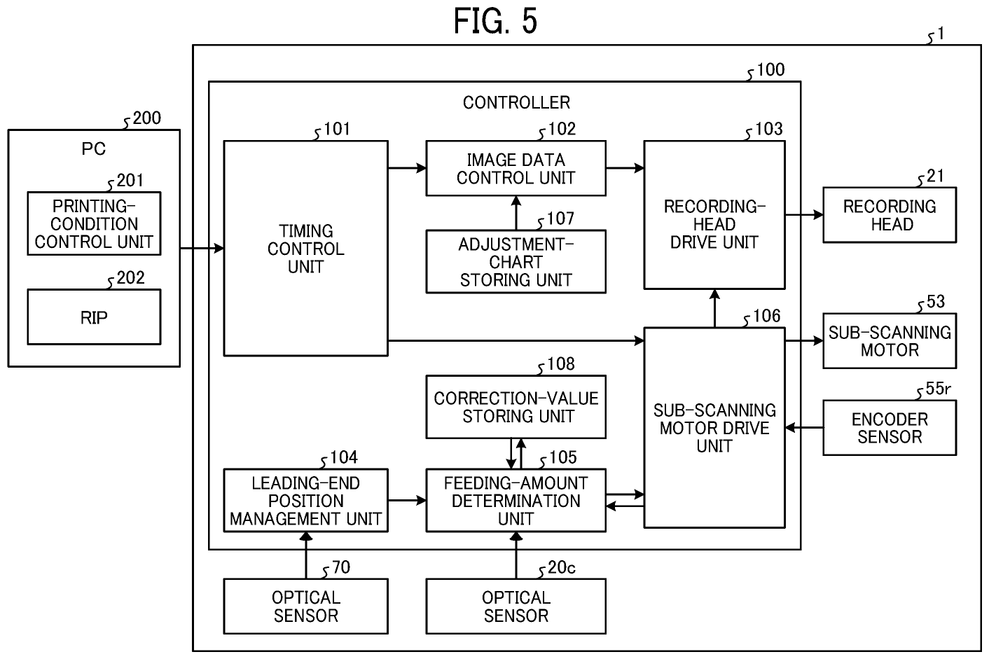

Next, a configuration example of the functional block of the image forming apparatus 1 according to an embodiment of the present disclosure is described with reference to FIG. 5. FIG. 5 is a block diagram illustrating an example of the functional configuration of the image forming apparatus 1 according to the present embodiment.

As illustrated in FIG. 5, the image forming apparatus 1 includes a controller 100 connected to each part of the image forming apparatus 1 and connected to a personal computer (PC) 200 or the like which is an external device of the image forming apparatus 1.

The PC 200 is, for example, a computer owned by a user of the image forming apparatus 1, and includes a printing-condition control unit 201 and a raster image processor (RIP) 202 for printing using the image forming apparatus 1.

The printing-condition control unit 201 specifies the print mode in the image forming apparatus 1 based on, for example, an instruction input to the PC 200 by the user. The contents that can be specified in the print mode include, for example, color or monochrome, color profile (color characteristics), resolution, moving speed of the carriage 2, and the like. The RIP 202 is, for example, a RIP-2 or the like that generates, as raster-shaped data, image data used when the image forming apparatus 1 performs image formation.

The PC 200 transmits the image data generated by the above-described functions to the controller 100 of the image forming apparatus 1.

The controller 100 of the image forming apparatus 1 is configured as a computer including, for example, a central processing unit (CPU), a read only memory (ROM), a random access memory (RAM), and the like, and controls the entire image forming apparatus 1. Under the control of the controller 100, the image forming apparatus 1 forms (prints) an image on the recording medium M or the like according to, for example, image data or the like transmitted from the PC 200.

In order to implement the above functions, the controller 100 includes, for example, a timing control unit 101, an image data control unit 102, a recording-head drive unit 103, a leading-end position management unit 104, a feeding-amount determination unit 105, a sub-scanning motor drive unit 106, and an adjustment-chart storing unit 107 and a correction-value storing unit 108.

The timing control unit 101 generates timing signals for controlling the timing of the reciprocating movement of the carriage 2 in the main scanning direction A and the timing of conveying the recording medium M or the like in the sub-scanning direction B. Further, the timing control unit 101 transmits the generated timing signal to the recording-head drive unit 103 via the image data control unit 102 and also transmits the generated timing signal to the sub-scanning motor drive unit 106.

The image data control unit 102 transfers the image data received from the PC 200 or the like to the recording-head drive unit 103. The image data control unit 102 reads out chart data including the information of the adjustment chart described later, which is stored in the adjustment-chart storing unit 107, and transfers the chart data to the recording-head drive unit 103. The image data control unit 102 transmits the timing signal received from the timing control unit 101 to the recording-head drive unit 103.

The recording-head drive unit 103 causes the recording head 21 to discharge ink according to the image data transferred from the image data control unit 102, while reciprocating the recording head 21 mounted on the carriage 2 in the main scanning direction A based on the timing signal transferred from the image data control unit 102, to form an image on the recording medium M or the like.

When the chart data is transmitted from the image data control unit 102, the recording-head drive unit 103 reciprocates the recording head 21 mounted on the carriage 2 in the main scanning direction A based on the timing signal transferred from the image data control unit 102. During reciprocation of the recording head 21, the recording-head drive unit 103 causes the recording head 21 to discharge ink according to information of an adjustment chart included in the chart data received from the image data control unit 102, to form the adjustment chart on a test medium for determining the proper feeding amount, in other words, the conveyance distance in the sub-scanning direction B.

The leading-end position management unit 104 grasps the leading end position of the recording medium M or the above-mentioned test medium or the like based on the output voltage from the optical sensor 70. The leading-end position management unit 104 transmits the grasped information on the leading end position of the recording medium M, the test medium, or the like to the feeding-amount determination unit 105.

When the adjustment chart is formed on the test medium, the feeding-amount determination unit 105 causes the optical sensor 20c to read the adjustment chart on the test medium, and acquires the result of reading as imaging data. The feeding-amount determination unit 105 analyzes the acquired imaging data, associates the analysis result with the leading end position of the test medium received from the leading-end position management unit 104, and generates a correction value for conveying the recording medium M or the like at a constant feeding amount. The feeding-amount determination unit 105 stores the generated correction value in the correction-value storing unit 108.

When a normal image is formed on the recording medium M, the feeding-amount determination unit 105 appropriately reads out a correction value from the correction-value storing unit 108 based on the leading end position of the recording medium M received from the leading-end position management unit 104 and transmits the correction value to the sub-scanning motor drive unit 106.

When the sub-scanning motor drive unit 106 forms an adjustment chart on the test medium, the sub-scanning motor drive unit 106 controls the rotation amount and rotation speed of the sub-scanning motor 53 according to a timing signal received from the timing control unit 101 and an output from the encoder sensor 55r that detects the rotation amount of the conveying roller 51 described above so that the test medium is conveyed at a predetermined feeding amount.

When an image is formed on the recording medium M, the sub-scanning motor drive unit 106 controls the rotation amount and rotation speed of the sub-scanning motor 53, while appropriately correcting the rotation amount and rotation speed of the sub-scanning motor 53, according to the timing signal received from the timing control unit 101, the correction value received from the feeding-amount determination unit 105, and the output from the encoder sensor 55r so that the recording medium M is conveyed with a constant feeding amount.

The recording-head drive unit 103 and the sub-scanning motor drive unit 106 control the recording head 21 and the sub-scanning motor 53 in synchronization with a common timing signal from the timing control unit 101. Thus, the printing and conveyance of the recording medium M can be alternately performed at appropriate timings, and a desired image can be formed on the recording medium M or the like.

The adjustment-chart storing unit 107 stores chart data including information about the adjustment chart. In the correction-value storing unit 108, correction values generated by the feeding-amount determination unit 105 are collectively stored in the correction value table described later. The adjustment-chart storing unit 107 and the correction-value storing unit 108 may be independent as different functional units, or may be configured as one functional unit in which the chart data and the correction value table are stored. The adjustment-chart storing unit 107 and the correction-value storing unit 108 may be implemented by, for example, a storage device such as a memory.

### Example of Correction of Feeding Amount by Image Forming Apparatus

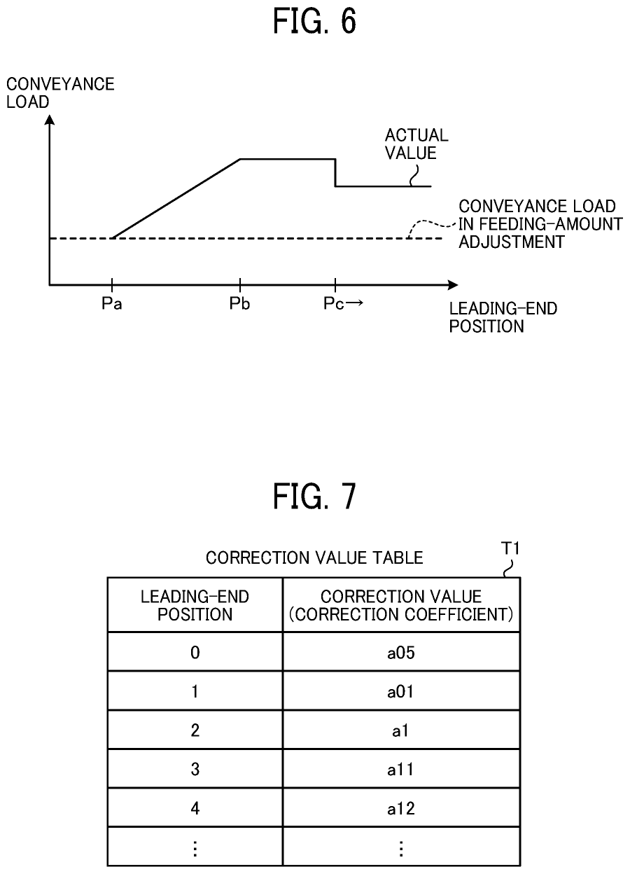

Next, correction of feeding amount of the recording medium M by the image forming apparatus 1 according to an embodiment of the present disclosure is described with reference to FIGS. 6 and 7. Hereinafter, an example in which a predetermined image is printed (formed) on a predetermined recording medium M is described.

First, a predetermined recording medium M is set in the image forming apparatus 1 in a state of being wound around the feeding roll 41, and one end of the long-shaped recording medium M, that is, a leading end of the long-shaped recording medium M in the sub-scanning direction B is pulled out onto the platen 7. The leading end position of the recording medium M on the platen 7 is set, for example, to a position slightly before the above-mentioned optical sensor 70, that is, a position upstream from the optical sensor 70 in the sub-scanning direction B.

In this state, when the user sends image data to the image forming apparatus 1 through, for example, the PC 200 and issues an image printing instruction, the image forming apparatus 1 starts conveying the recording medium M. When the leading end position of the recording medium M is detected by the optical sensor 70, the controller 100 of the image forming apparatus 1 adjusts the feeding amount to a value suitable for the recording medium M.

If the type of the recording medium M is different, the frictional force with the platen 7 or the like is different, and the appropriate feeding amount for forming a high-quality image is also different for each recording medium M. Therefore, the feeding amount is adjusted at the initial stage of conveying the recording medium M, and the feeding amount is adjusted to an appropriate value according to the type of the recording medium M and the like. After that, the controller 100 of the image forming apparatus 1 controls the conveying mechanism so that, for example, the driving force of the feeding motor 43 be constant.

However, as described below, since the value of the conveyance load and the like change depending on the leading end position of the recording medium M, it may be difficult to keep the feeding amount of the recording medium M appropriate only by keeping the driving force of the feeding motor 43 constant.

FIG. 6 is a graph illustrating an example of transition of the conveyance load in the image forming apparatus 1 according to an embodiment of the present disclosure. The horizontal axis of the graph of FIG. 6 is the leading end position of the recording medium M, and the vertical axis of the graph of FIG. 6 is the conveyance load.

As illustrated in FIG. 6, at the initial stage of conveyance of the recording medium M, the feeding amount is adjusted to be appropriate for the recording medium M by the feeding amount adjustment. When the leading end position of the recording medium M is in the section Pa-Pb between the installation position (Pa) of the optical sensor 70 and the end position (Pb) on the downstream side of the platen 7, the conveyance load of the recording medium M increases with respect to the conveyance load at the initial stage. This is because, as the contact area between the recording medium M and the platen 7 increases, the frictional force between the recording medium M and the platen 7 increases.

When the leading end position of the recording medium M is in the section Pb-Pc past the end position (Pb) on the downstream side of the platen 7 and reaching the winding position (Pc) by the winding roll 61, there is no change in the contact area and frictional force between the test medium Mt and the platen 7, and the conveyance load of the recording medium M is kept constant at a high value.

When the leading end position of the recording medium M reaches the winding unit 60 and is in the section Pc→ beyond the winding position (Rs) at which the recording medium M is stably wound by the winding roll 61, the winding tension is applied to the recording medium M by the driving force of the winding motor 63. Accordingly, the conveyance load of the recording medium M decreases and is stabilized at a value higher than, for example, the conveyance load in the state in which the feeding amount is appropriately adjusted at the initial stage of the start of conveyance.

As described above, if the conveyance load of the image forming apparatus 1 fluctuates while the driving force of the feeding motor 43 is kept constant, the feeding amount of the recording medium M also fluctuates. Hence, the controller 100 of the image forming apparatus 1 refers to the correction value table stored in the correction-value storing unit 108, and corrects the feeding amount of the recording medium M by the conveying roller 51 based on the correction value according to the leading end position of the recording medium M.

FIG. 7 is a diagram illustrating an example of a correction value table T1 possessed by the image forming apparatus 1 according to an embodiment of the present disclosure.

As illustrated in FIG. 7, the correction value table T1 includes a plurality of correction values. The correction values are associated with the leading end positions of the recording medium M at a plurality of time points.

For example, an individual correction value is set at least for each of the above-described sections Pa-Pb, Pb-Pc, and Pc→. Further, an interpolated correction value connecting the individual sections Pa-Pb, Pb-Pc, and Pc→ may be set. The interpolated correction value is a correction value that fills the gap between the correction values set for the respective sections Pa-Pb, Pb-Pc, and Pc→.

Further, in the section Pa-Pb in which the conveyance load continuously changes, a correction value may be set for each feeding amount at which the recording medium M is fed in the sub-scanning direction B, for example, each time the carriage 2 is scanned once in the main scanning direction A, that is, for each scan. Alternatively, for the other sections Pb-Pc and Pc→, a correction value may also be set for the feeding amount for each scan.

When the controller 100 of the image forming apparatus 1 detects the leading end position of the recording medium M by the optical sensor 70, the controller 100 conveys the recording medium M with an appropriate feeding amount at the initial stage of the start of conveyance, and starts printing and image on the recording medium M.

Further, the controller 100 estimates, from the rotation speed of the conveying roller 51, the subsequent leading end position of the recording medium M based on the leading end position of the recording medium M detected by the optical sensor 70. The controller 100 selects a correction value corresponding to the leading end position of the recording medium M thus estimated from the correction value table T1. The controller 100 uses the correction value selected from the correction value table T1 as a coefficient (correction coefficient) to correct, for example, the driving force of the sub-scanning motor 53.

As a result, the conveying roller 51 is rotated by the sub-scanning motor 53 whose driving force is appropriately corrected, and the recording medium M is appropriately moved in the sub-scanning direction B. Thus, the feeding amount of the recording medium M is corrected for each of the above-described sections Pa-Pb, Pb-Pc, and Pc→ or each scan of the carriage 2.

Accordingly, regardless of whether the leading end position of the recording medium M is in any of the sections Pa-Pb, Pb-Pc, and Pc→, an appropriate feeding amount is maintained and a high-quality image is formed on the recording medium M. When interpolating correction values connecting the sections Pa-Pb, Pb-Pc, and Pc→ are set, the correction values are switched when the sections Pa-Pb, Pb-Pc, and Pc→ are switched. Thus, fluctuations in the feeding amount of the recording medium M are restrained.

### Example of Calculation of Correction Value by Image Forming Apparatus

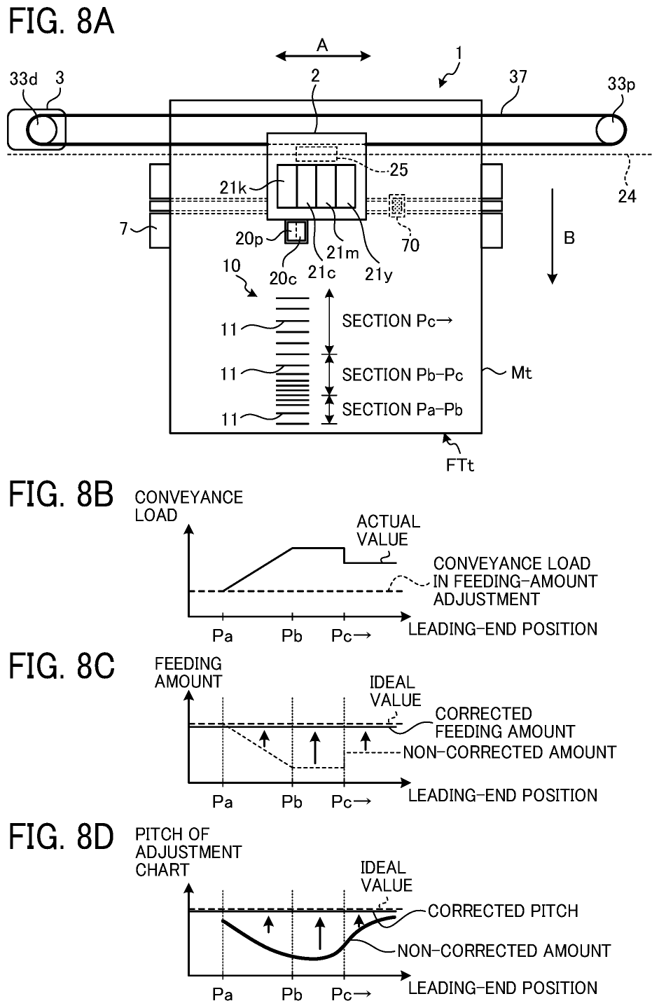

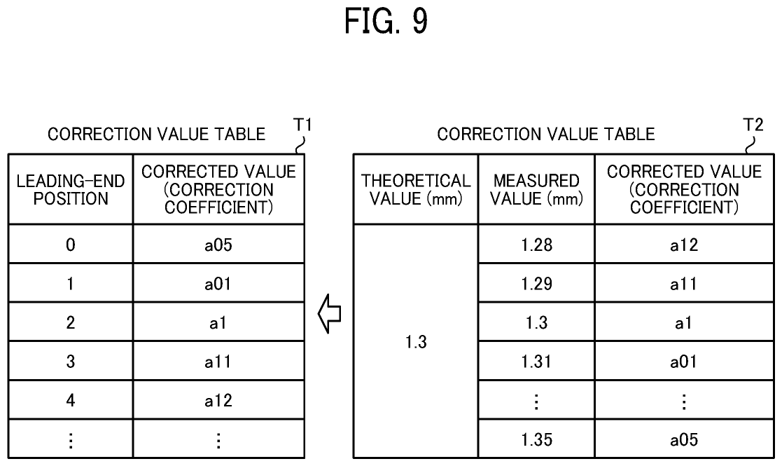

Next, the calculation of the correction value of the feeding amount of the recording medium M by the image forming apparatus 1 according to an embodiment of the present disclosure is described with reference to FIGS. 8A, 8B, 8C, 8D, and 9.

As described above, in the image forming apparatus 1, the feeding amount of the recording medium M is corrected using the correction value table T1 so that the feeding amount of the recording medium M does not fluctuate depending on the leading end position of the recording medium M being conveyed. The individual correction values in the correction value table T1 are calculated in advance using the adjustment chart.

In the image forming apparatus 1, various recording media M having different sizes, materials, thicknesses, and the like can be printed targets. For this reason, the correction value is preferably set for each different recording medium M, and the adjustment chart used for determining the correction value is printed on a test medium of the same type as the recording medium M to be corrected.

When the adjustment chart is printed, the test medium is set in the image forming apparatus 1 in a state of being wound around the feeding roll 41, and one end of the test medium having a long shape, that is, the leading end of the test medium is pulled out onto the platen 7. The leading end position of the test medium on the platen 7 is set to, for example, a position slightly before the optical sensor 70, in other words, a position upstream from the optical sensor 70, as in the case of the recording medium M described above.

In such a state, for example, when the user issues a printing command of an adjustment chart to the image forming apparatus 1 through the PC 200 or the like, the image forming apparatus 1 starts conveying the test medium. When the leading end position of the test medium is detected by the optical sensor 70, the controller 100 starts printing the adjustment chart on the test medium while adjusting the feeding amount so as to be appropriate for the test medium.

After that, the controller 100 of the image forming apparatus 1 controls the conveying mechanism so that the driving force of the feeding motor 43 be constant. When the adjustment chart is printed, the controller 100 also controls the driving force of the sub-scanning motor 53 to be constant.

The test medium is intermittently conveyed to the downstream side while the adjustment chart is printed on the upper surface. After the leading end position reaches the winding unit 60, the test medium is wound by the winding roll 61.

FIG. 8A is a schematic view illustrating a state in which an adjustment chart 10 is printed on a test medium Mt by the image forming apparatus 1 according to an embodiment of the present disclosure.

The adjustment chart 10 printed on the test medium Mt includes a plurality of adjustment lines 11. The plurality of adjustment lines 11 are printed, for example, one line each time the carriage 2 is scanned once in the main scanning direction A, in other words, one line is printed for each scan. Accordingly, if the feeding amount per scan of the test medium Mt is constant, the adjustment lines 11 are arranged on the test medium Mt at equal intervals.

However, even in the test medium Mt of the same type as the recording medium M, the conveyance load varies depending on the leading end position FTt of the test medium Mt. When the adjustment chart 10 is printed, the driving force of the sub-scanning motor 53 is kept constant. Accordingly, the feeding amount of the test medium Mt and the pitch of the adjustment chart 10 printed on the test medium Mt fluctuate.

The graphs of FIGS. 8B to 8D illustrate the relations between the leading end position FTt of the test medium Mt, the conveyance load and feeding amount during conveyance of the test medium Mt, and the pitch of the adjustment lines 11 of the adjustment chart 10.

As illustrated in FIG. 8B, the conveyance load during conveyance of the test medium Mt varies in the same manner as the conveyance load during conveyance of the recording medium M of the same type.

As illustrated in FIG. 8C, when the leading end position FTt of the test medium Mt is in the section Pa-Pb in which the conveyance load of the test medium Mt increases, for example, the feeding amount per scan of the test medium Mt decreases and dissociates from an ideal feeding amount. The ideal feeding amount is, for example, a feeding amount appropriately adjusted at the initial stage of the start of conveyance.

When the leading end position FTt of the test medium Mt is in the section Pb-Pc in which the conveyance load of the test medium Mt is constant, for example, the feeding amount per scan of the test medium Mt is constant in a state of being dissociated from an ideal value.

When the leading end position FTt of the test medium Mt is in the section Pc→ in which the conveyance load of the test medium Mt decreases, for example, the feeding amount per scan of the test medium Mt sharply increases and remains constant in a state of being dissociated from the ideal value.

As illustrated in FIG. 8D, when the leading end position FTt of the test medium Mt is in the section Pa-Pb in which the conveyance load of the test medium Mt increases, the pitch of the adjustment lines 11 decreases as the feeding amount per scan of the test medium Mt decreases.

When the leading end position FTt of the test medium Mt is in the section Pb-Pc in which the conveyance load of the test medium Mt is constant, the feeding amount per scan of the test medium Mt is constant. Accordingly, the pitch of the adjustment lines 11 is stable in a narrowed state.

When the leading end position FTt of the test medium Mt is in the section Pc→ in which the conveyance load of the test medium Mt decreases, the pitch of the adjustment lines 11 stabilizes at regular intervals as the feeding amount per scan of the test medium Mt is constant in an increased state.

As described above, there is a correlation between the conveyance load of the test medium Mt, the feeding amount, and the pitch of the adjustment chart 10. Thus, reading the pitch of the adjustment chart 10 can determine the feeding amount of the test medium Mt when the sub-scanning motor 53 is driven by a predetermined driving force.

Further, based on the read pitch of the adjustment chart 10, for example, a correction value for each of the sections Pa-Pb, Pb-Pc, and Pc→ or for each scan can be calculated. As described above, the interpolated correction values connecting the sections Pa-Pb, Pb-Pc, and Pc→ may be calculated.

In other words, the controller 100 of the image forming apparatus 1 calculates a correction value so that the corrected feeding amount of the recording medium M and the test medium Mt approaches a value of the feeding amount that is appropriately adjusted at the initial stage of the start of conveyance, in other words, the ideal value in FIG. 8C. Further, after the feeding amount is corrected with such a correction value, the pitches of the adjustment lines 11 of the adjustment chart 10 are intervals close to the value at the time of adjusting the feeding amount at the initial stage of the start of conveyance, that is, the ideal value in FIG. 8C and ae substantially uniform intervals.

Hence, the controller 100 of the image forming apparatus 1 causes the above-mentioned optical sensor 20c to read the individual adjustment lines 11 of the adjustment chart 10.

The printing of the adjustment chart 10 is preferably continued until the pitches of the adjustment lines 11 become uniform in the above-described section Pc→. The fact that the pitches of the adjustment lines 11 are uniform can be determined on the condition that, for example, the measured pitches vary within 5% for 10 consecutive times.

Alternatively, the printing of the adjustment chart 10 may be defined to be continued until, for example, the number of adjustment lines 11 included in the above-described section Pc→ becomes 10 or more, or the length of the adjustment chart 10 in the above-described section Pc→ is equal to or longer than a predetermined length.

Any print end condition of the adjustment charts 10 can be determined based on a desired quality in image formation.

The controller 100 acquires, for example, a measured value of the feeding amount for each scan from the pitch of the adjustment lines 11 of the read adjustment chart 10 and calculates a correction value based on the acquired measured value. For the calculation of the correction value, a correction value table T2 different from the above-mentioned correction value table T1 stored in the correction-value storing unit 108 is used.

FIG. 9 is a diagram illustrating an example of correction value tables T1 and T2 possessed by the image forming apparatus 1 according to an embodiment of the present disclosure. As illustrated in FIG. 9, the correction value table T2 includes a theoretical value of the feeding amount, a plurality of measured values of the feeding amount, and a plurality of correction values corresponding to the measured values. The correction value table T2 is obtained by, for example, simulation, and the image forming apparatus 1 has, for example, the correction value table T2 as initial data.

The controller 100 refers to, for example, the correction value table T2 illustrated in FIG. 9 and obtains a correction value corresponding to the acquired measured value of the feeding amount. The controller 100 associates the acquired correction value with the leading end position FTt of the test medium Mt at that time to generate a correction value table T1, and stores the generated correction value table T1 in the correction-value storing unit 108.

When printing is performed next time on the recording medium M of the same type as the test medium Mt used for calculating the correction value, the correction value table T1 stored in the correction-value storing unit 108 is read from the correction-value storing unit 108 and used for correcting the feeding amount of the recording medium M as described above.

Although the correction value is calculated and set for each different recording medium M, the correction value is more preferably calculated and set for each print mode even for the same type of recording medium M. When the correction value is calculated and set for each print mode, the same procedure as described above can be used.

### Example of Processing by Image Forming Apparatus

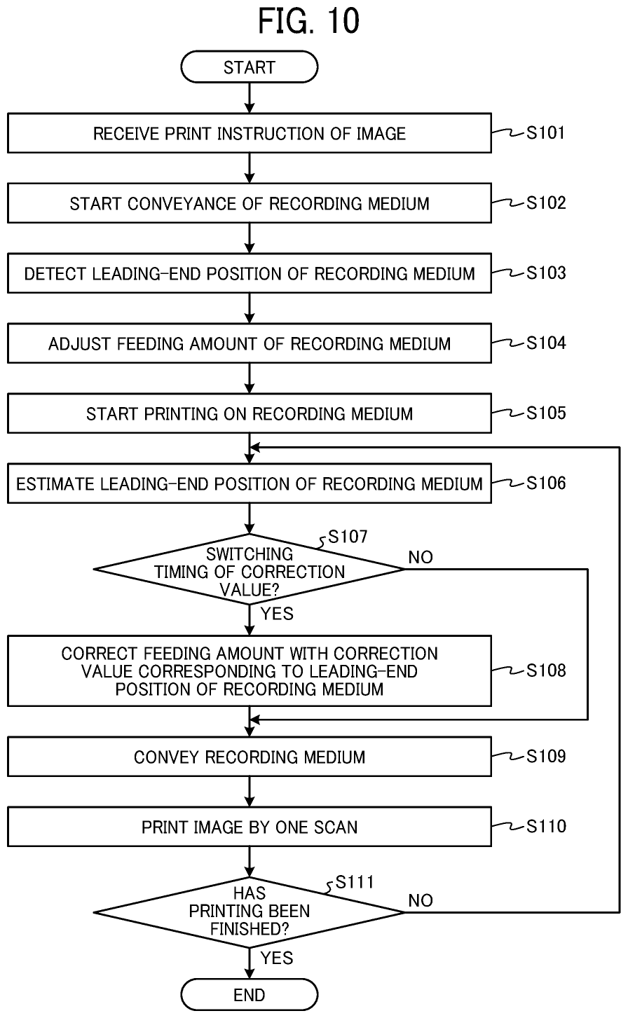

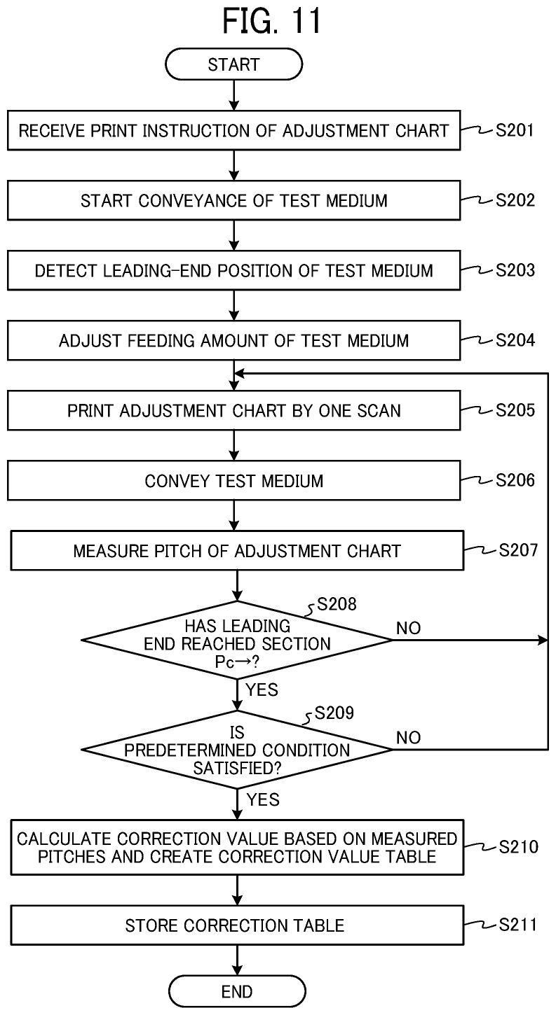

Next, an example of processing by the image forming apparatus 1 of an embodiment of the present disclosure is described with reference to FIGS. 10 and 11.

FIG. 10 is a flowchart illustrating an example of the procedure of a printing process by the image forming apparatus 1 according to an embodiment of the present disclosure. At the start of the process illustrated in FIG. 10, it is assumed that the correction value table T1 for the desired recording medium M is stored in the correction-value storing unit 108 of the image forming apparatus 1. A desired recording medium M is assumed to be already set in the image forming apparatus 1 in a state in which the recording medium M is wound around the feeding roll 41 and the leading end position of the recording medium M is pulled out on the platen 7.

As illustrated in FIG. 10, when the image forming apparatus 1 receives an image printing instruction together with the image data desired to be printed from, for example, the user's PC 200 (step S101), the image forming apparatus 1 starts conveying the recording medium M set in the image forming apparatus 1 (step S102).

More specifically, the timing control unit 101 generates a timing signal and transmits the timing signal to the image data control unit 102 and the sub-scanning motor drive unit 106. The image data control unit 102 transfers the received timing signal to the recording-head drive unit 103.

Accordingly, the recording-head drive unit 103 and the sub-scanning motor drive unit 106 control the recording head 21 and the sub-scanning motor 53, respectively, in synchronization with the timing signal, and the recording medium M is started to be conveyed.

The leading-end position management unit 104 detects the leading end position of the recording medium M based on the output from the optical sensor 70 (step S103). The feeding-amount determination unit 105 adjusts the feeding amount so as to be suitable for the recording medium M set in the image forming apparatus 1 (step S104).

More specifically, the feeding-amount determination unit 105 transmits information on the feeding amount suitable for the recording medium M to the sub-scanning motor drive unit 106. The sub-scanning motor drive unit 106 controls the sub-scanning motor 53 based on the information received from the feeding-amount determination unit 105 to convey the recording medium M with an appropriate feeding amount. After that, the sub-scanning motor drive unit 106 continues to control the sub-scanning motor 53 while receiving feedback from the encoder sensor 55r that detects the amount of rotation of the conveying roller 51.

The controller 100 starts printing the image data received from the PC 200 (step S105).

More specifically, the image data control unit 102 transfers the image data received from the PC 200 to the recording-head drive unit 103. The recording-head drive unit 103 and the sub-scanning motor drive unit 106 control the recording head 21 and the sub-scanning motor 53, respectively, in synchronization with the timing signal, and the recording-head drive unit 103 controls the recording head 21 based on the image data to start printing an image on the recording medium M.

At this time, the sub-scanning motor drive unit 106 acquires the output from the encoder sensor 55r, and the feeding-amount determination unit 105 transmits the output of the encoder sensor 55r acquired by the sub-scanning motor drive unit 106 to the leading-end position management unit 104.

After the leading end position of the recording medium M is detected by the optical sensor 70, the leading-end position management unit 104 estimates the leading end position of the recording medium M at that time based on the output of the encoder sensor 55r (step S106).

The feeding-amount determination unit 105 determines whether it is timing to switch the correction value for correcting the feeding amount of the recording medium M based on the current leading end position of the recording medium M estimated by the leading-end position management unit 104 (step S107).

The timing of switching the correction value is, for example, the timing of first applying the correction value in order to maintain the feeding amount adjusted at the initial stage of the start of conveyance.

For example, when the correction value is set for each of the sections Pa-Pb, Pb-Pc, and Pc→, the switching timing of the correction value is the timing at which the leading end position of the recording medium M has moved across each of the sections Pa-Pb, Pb-Pc, and Pc→.

When the interpolated correction values connecting the individual sections Pa-Pb, Pb-Pc, and Pc→ are set, the timing at which the leading end position of the recording medium M is moving across each of the sections Pa-Pb, Pb-Pc, and Pc→ may also correspond to the timing of switching the correction value.

Alternatively, for example, when the correction value is set for each predetermined number of scans such as for each scan, the correction value switching timing occurs every predetermined number of scans.

When it is timing to switch the correction value (YES in step S107), the feeding-amount determination unit 105 corrects the feeding amount with a correction value corresponding to the leading end position of the recording medium M at that time (step S108).

More specifically, the feeding-amount determination unit 105 refers to the correction value table T1 stored in the correction-value storing unit 108, and selects a correction value corresponding to the leading end position of the recording medium M at that time. The feeding-amount determination unit 105 transmits the selected correction value to the sub-scanning motor drive unit 106.

If it is not the timing to switch the correction value (NO in step S107), the feeding-amount determination unit 105 does not perform the processing of step S108.

The sub-scanning motor drive unit 106 conveys the recording medium M by the feeding amount for one scan (step S109).

More specifically, when the sub-scanning motor drive unit 106 receives the correction value from the feeding-amount determination unit 105, the sub-scanning motor drive unit 106 corrects, for example, the driving force of the sub-scanning motor 53 based on the correction value to correct the feeding amount of the recording medium M fed by the conveying roller 51.

When the feeding-amount determination unit 105 does not instruct the sub-scanning motor drive unit 106 to switch the correction value, for example, the sub-scanning motor drive unit 106 maintains the driving force of the sub-scanning motor 53 up to that point to maintain the feeding amount of the recording medium M by the conveying roller 51 constant.

When the recording medium M is conveyed by the feeding amount for one scan, the recording-head drive unit 103 controls the recording head 21 based on the image data to form an image for one scan on the recording medium M (step S110).

The controller 100 determines whether printing of the image based on the image data has been finished (step S111). If printing has not been finished (NO in step S111), the controller 100 repeats the process from step S106. If printing has been finished (YES in step S111), the controller 100 ends the process.

As described above, the printing process by the image forming apparatus 1 of the present embodiment is completed.

FIG. 11 is a flowchart illustrating an example of a procedure for calculating a correction value by the image forming apparatus 1 according to an embodiment of the present disclosure. When the process illustrated in FIG. 11 is started, it is assumed that the correction value table T2 is stored in the correction-value storing unit 108 of the image forming apparatus 1. In the image forming apparatus 1, a test medium Mt of the same type as the recording medium M for which a correction value is to be obtained is already set in a state in which the test medium Mt is wound around the feeding roll 41 and the leading end position of the test medium Mt is pulled out onto the platen 7.

As illustrated in FIG. 11, when the image forming apparatus 1 receives, for example, a print instruction of the adjustment chart 10 from the user's PC 200 (step S201), the image forming apparatus 1 starts conveying the test medium Mt (step S202).

The leading-end position management unit 104 detects the leading end position of the test medium Mt based on the output from the optical sensor 70 (step S203). The feeding-amount determination unit 105 adjusts the feeding amount so as to be suitable for the test medium Mt set in the image forming apparatus 1 (step S204).

The controller 100 prints the adjustment chart 10 for one scan (step S205).

More specifically, the timing control unit 101 generates a timing signal and transmits the timing signal to the image data control unit 102 and the sub-scanning motor drive unit 106. The image data control unit 102 transfers the received timing signal to the recording-head drive unit 103. The image data control unit 102 transfers the chart data stored in the adjustment-chart storing unit 107 to the recording-head drive unit 103.

Accordingly, the recording-head drive unit 103 and the sub-scanning motor drive unit 106 control the recording head 21 and the sub-scanning motor 53, respectively, in synchronization with the timing signal, and the recording-head drive unit 103 controls the recording head 21 based on the chart data to print the adjustment chart 10 for one scan on the test medium Mt.

When the adjustment chart 10 for one scan is printed, the sub-scanning motor drive unit 106 controls the sub-scanning motor 53 to convey the test medium Mt by the feeding amount for one scan (step S206).

The feeding-amount determination unit 105 reads the adjustment chart 10 imaged by the optical sensor 20c and measures the pitch between the adjustment lines 11 included in the adjustment chart 10 (step S207).

The feeding-amount determination unit 105 determines whether the leading end position of the test medium Mt has reached the section Pc→ based on the pitch between the measured adjustment lines 11 (step S208). If the leading end position of the test medium Mt has not reached the section Pc→ (NO in step S208), the controller 100 repeats the process from step S205.

If the leading end position of the test medium Mt has reached the section Pc→ (YES in step S208), the feeding-amount determination unit 105 determines whether the state of the adjustment chart 10 satisfies the predetermined condition (step S209).

The condition to be satisfied by the adjustment chart 10 is a condition for determining whether the pitches of the adjustment lines 11 are uniform, for example, the pitches of the adjustment lines 11 in the section Pc→ varies within 5% for 10 consecutive times.

Alternatively, the condition to be satisfied by the adjustment chart 10 is that, for example, ten or more adjustment lines 11 in the section Pc→ have been printed or, for example, the length of the adjustment chart 10 printed in the section Pc→ is a predetermined length.

If the state of the adjustment chart 10 does not satisfy the predetermined condition (NO in step S209), the controller 100 repeats the process from step S205.

If the state of the adjustment chart 10 satisfies the predetermined condition (YES in step S209), the feeding-amount determination unit 105 calculates correction values based on the pitches measured for all the adjustment lines 11 included in the adjustment chart 10, and generates the correction value table T1 (step S210).

When the correction values are calculated, the feeding-amount determination unit 105 refers to, for example, the correction value table T2 stored in the correction-value storing unit 108, and selects the correction value corresponding to each measured value. The feeding-amount determination unit 105 associates the correction value with the leading end position of the test medium Mt corresponding to each measured value, and generates the correction value table T1. At this time, the feeding-amount determination unit 105 may calculate an interpolated correction value that fills an interval between the measured values.

The feeding-amount determination unit 105 stores the generated correction value table T1 in the correction-value storing unit 108 (step S211).

As described above, the correction-value calculation process by the image forming apparatus 1 according to an embodiment of the present disclosure is completed.

### Comparative Example

Hereinafter, the configurations of some comparative examples are described in comparison with the configuration of the image forming apparatus 1 according to an embodiment of the present disclosure.

In an inkjet printer, if the feeding amount of a recording medium is not appropriate, defects such as banding in which streaks appear in a printed image may occur, and the image quality may deteriorate. Hence, in order to enhance the image quality of the printed image, for example, there is a technology of correcting the feeding amount of the recording medium for each recording medium or by the remaining amount of the recording medium in a sheet feed or ejection unit.

For example, in a first comparative example, in order to reduce the difference in the amount of movement of a sheet roll between the conveyance to the downstream side and the conveyance to the upstream side, the amount of movement of the sheet roll is corrected based on the amount of deviation of the physical leading end position of the sheet roll from the logical leading end position of the sheet roll.

For example, in a second comparative example, in order to restrain loosening of a roll-shaped print medium, the suction area of the print medium by a suction unit provided on a platen is specified based on the position of the leading end side of the print medium. The drive amount of a motor that drives a roll body that supplies the print medium is adjusted according to the suction area.

However, the technology of the first comparative example does not correct an error in the amount of movement of a sheet roll that occurs due to the frictional force between the sheet roll and the platen fluctuating depending on the leading end position of the sheet roll.

Further, in the technology of the second comparative example, only the motor drive amount on the supply side of the print medium is adjusted. It is difficult for such adjustment only to prevent a decrease in the conveyance accuracy of a moving medium caused by the movement of the leading end position of the print medium from the platen to the sheet ejection side.

As described above, the feeding amount of the recording medium continues to fluctuate, for example, while the leading end position of the recording medium moves from the platen to a winding unit. Hence, it is conceivable to start the printing process in a state in which the leading end portion of the recording medium is wound around a winding roll of the winding unit, in other words, in a state in which the fluctuation of the feeding amount does not occur. However, the recording medium from the printing area directly under a carriage to the winding unit is wasted, and the running cost may increase.

In the image forming apparatus 1 according to an embodiment of the present disclosure, the feeding amount of a recording medium M by the conveying roller 51 is corrected with a correction value according to the leading end position of the recording medium M detected by the optical sensor 70. Thus, the conveyance accuracy of the recording medium can be enhanced.

In the image forming apparatus 1 according to an embodiment of the present disclosure, the correction value is switched depending on whether the current leading end position of the recording medium M is in the section Pa-Pb, the section Pb-PC, or the section Pc→. As described above, the correction value is switched for each of the sections Pa-Pb, Pb-Pc, and Pc→ in which the feeding amount of the recording medium M may greatly fluctuate, thus effectively enhancing the conveyance accuracy of the recording medium M.

For the image forming apparatus 1 according to the present embodiment, in at least one of the case in which the current leading end position of the recording medium M is moving from the section Pa-Pb to the section Pb-Pc and the case in which the current leading end position of the recording medium M is moving from the section Pb-Pc to the section Pc→, the feeding amount of the recording medium M by the conveying roller 51 is corrected with a correction value that interpolates between the sections. Such a configuration can restrain fluctuations in the feeding amount of the recording medium M before and after switching the correction value for each of the sections Pa-Pb, Pb-Pc, and Pc→.

In the image forming apparatus 1 according to an embodiment of the present disclosure, when the current leading end position of the recording medium M is in the section Pa-Pb, the correction value is further changed. As described above, changing the correction value in the section Pa-Pb in which the feeding amount of the recording medium M can change momentarily, the conveyance accuracy of the recording medium can be further enhanced.

### Other Variations

In the above-described embodiment, the leading end positions of the recording medium M and the test medium Mt are detected using the optical sensor 70.

However, the optical sensor 20p that detects the width of the recording medium M or the like may be diverted to detect the leading end positions of the recording medium M and the test medium Mt. Such a configuration can obviates the need to separately install the optical sensor 70 for detecting the leading end position, thus allowing cost reduction of the apparatus.

Alternatively, instead of using the optical sensors 70, 20p, or the like, for example, a mark may be provided at a predetermined position on the platen 7 of the image forming apparatus 1. In such a case, the user can adjust the leading end position of the recording medium M or the like to the mark to specify the leading end position of the medium M or the like.

In the above-described embodiment, the adjustment chart 10 on the test medium Mt is read using the optical sensor 20c. However, in some embodiments, the user or the like may visually read the adjustment chart 10.

In the above-described embodiment, correction values corresponding to the leading end positions of the recording medium M are prepared. The feeding amount of the recording medium M is appropriately corrected with the correction values until the leading end position of the recording medium M moves from the platen 7 to the winding unit 60.

However, the feeding amount of the recording medium M may also vary depending on the trailing end position of the recording medium M when the remaining amount of the recording medium M is low.

In other words, when the trailing end position of the recording medium M is in the feeding unit 40 and in the section wound around the feeding roll 41, the feeding amount of the recording medium M is properly maintained by the correction having been made so far.

However, when the trailing end position of the recording medium M is in a section from the time when the trailing end position of the recording medium M is separated from the feeding roll 41 and the driving force by the feeding motor 43 is not transmitted to an end position on the upstream side of the platen 7, the feeding amount of the recording medium M sharply drops and is maintained in the dropped state.

Further, when the trailing end position of the recording medium M is in a section from the upstream end position of the platen 7 to a position at which the trailing end position passes through the arrangement position of the conveying roller 51, the feeding amount of the recording medium M gradually recovers from the sharply dropped state as the contact area and the frictional force between the recording medium M and the platen 7 decrease.

Accordingly, correction values corresponding to the trailing end positions of the recording medium M may be prepared. The feeding amount of the recording medium M may be appropriately corrected with the correction values while the trailing end position of the recording medium M moves from the feeding unit 40 to the installation position of the conveying roller 51.

As described above, performing corrections according to both the front end position and the trailing end position of the recording medium M allows the recording medium to be conveyed from a leading end portion to a trailing end portion of the recording medium M with high conveyance accuracy.

In the above-described embodiment, the image forming apparatus 1 has the correction-value calculation function.

However, in some embodiments, the image forming apparatus may not have a correction value calculation function. For example, a correction value table T1 calculated and generated by another image forming apparatus or the like may be used to appropriately correct the feeding amount of the recording medium M by the conveying roller 51.

In such a case, the image forming apparatus is configured so that the correction value table T1 generated by another image forming apparatus or the like can be acquired via a storage medium such as a solid state drive (SSD). Alternatively, the image forming apparatus and another image forming apparatus may be connected by wire or wirelessly, directly or via a server or the like. Thus, the image forming apparatus can download and acquire the correction value table T1 from another image forming apparatus or from the server.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. The elements of the above-described embodiments can be modified without departing from the gist of the present disclosure, and can be appropriately determined according to the application form.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus, comprising:
a feeding roll;
a feeding motor configured to rotate the feeding roll to feed a recording medium wound around the feeding roll;
a winding roll;
a winding motor configured to rotate the winding roll to wind the recording medium around the winding roll;
a platen disposed between the feeding roll and the winding roll and configured to support the recording medium that moves between the feeding roll and the winding roll;
a conveying roller configured to convey the recording medium supported by the platen toward the winding roll;
a sensor configured to detect an end position of the recording medium, which is supported by the platen, in a conveyance direction; and
circuitry configured to correct a feeding amount of the recording medium by the conveying roller with a correction value according to the end position of the recording medium detected by the sensor.

2. The image forming apparatus according to claim 1,
wherein the end position of the recording medium is a leading end position of the recording medium in the conveyance direction, and
wherein the circuitry is configured to switch the correction value depending on whether a current leading end position of the recording medium is in a first section from an installation position of the sensor to a downstream end position of the platen in the conveyance direction, a second section from the downstream end position of the platen to a winding position of the recording medium by the winding roll, or a third section in which the recording medium is wound around the winding roll.

3. The image forming apparatus according to claim 2,
wherein the circuitry is configured to correct the feeding amount of the recording medium by the conveying roller with the correction value corresponding to the current leading end position of the recording medium in at least one of when the current leading end position of the recording medium is moving from the first section to the second section and when the current leading end position of the recording medium is moving from the second section to the third section, and
wherein the correction value is a correction value interpolating between adjacent ones of the first section, the second section, and the third section.

4. The image forming apparatus according to claim 2,
wherein the circuitry is configured to further change the correction value when the current leading end position of the recording medium is in the first section.

5. The image forming apparatus according to claim 2,
wherein the sensor is configured to detect a width of the recording medium in a direction orthogonal to the conveyance direction.

6. The image forming apparatus according to claim 1,
wherein the end position of the recording medium is a trailing end position of the recording medium, and
wherein the circuitry is configured to switch the correction value depending on whether a current trailing end position of the recording medium is in a first section in which the recording medium is wound around the feeding roll, a second section from a separation position from the feeding roll to an upstream end position of the platen in the conveyance direction, or a third section from the upstream end position of the platen to an arrangement position of the conveying roller.

7. The image forming apparatus according to claim 6,
wherein the circuitry is configured to correct the feeding amount of the recording medium by the conveying roller with the correction value corresponding to the current trailing end position of the recording medium in at least one of when the current trailing end position of the recording medium is moving from the first section to the second section and when the current trailing end position of the recording medium is moving from the second section to the third section, and
wherein the correction value is a correction value interpolating between adjacent ones of the first section, the second section, and the third section.

8. The image forming apparatus according to claim 6,
wherein the circuitry is configured to further change the correction value when the current trailing end position of the recording medium is in the third section.

9. The image forming apparatus according to claim 1, further comprising a storage device configured to store a plurality of correction values corresponding to a plurality of positions that an end of the recording medium takes during conveyance between the feeding roll and the winding roll.

10. The image forming apparatus according to claim 1, further comprising a recording head configured to discharge liquid onto the recording medium supported on the platen,
wherein the recording head is configured to scan the recording medium in a direction orthogonal to the conveyance direction of the recording medium when the recording head discharges the liquid onto the recording medium,
wherein the conveying roller is configured to convey the recording medium with a predetermined feeding amount each time the recording head scans, and
wherein the circuitry is configured to set the correction value for each feeding amount of the recording medium by the conveying roller for each scan of the recording head.

11. The image forming apparatus according to claim 1, further comprising a recording head configured to discharge liquid onto the recording medium supported on the platen,
wherein the circuitry is configured to cause the recording head to discharge liquid onto a test medium of a same type as the recording medium, while causing the conveying roller to convey the test medium, to form an adjustment chart for distinguishing a feeding amount of the test medium by the conveying roller onto the test medium, and
wherein the circuitry is configured to calculate the correction value according to an end position of the recording medium, based on the feeding amount of the test medium by the conveying roller that is distinguished from the adjustment chart.

12. A conveying apparatus, comprising:
a feeding roll;
a feeding motor configured to rotate the feeding roll to feed a sheet material wound around the feeding roll;
a winding roll;
a winding motor configured to rotate the winding roll to wind the sheet material around the winding roll;
a platen disposed between the feeding roll and the winding roll and configured to support the sheet material that moves between the feeding roll and the winding roll;
a conveying roller configured to convey the sheet material supported by the platen toward the winding roll;
a sensor configured to detect an end position of the sheet material, which is supported by the platen, in a conveyance direction; and
circuitry configured to correct a feeding amount of the sheet material by the conveying roller with a correction value according to the end position of the sheet material detected by the sensor.
